(19) United States
(12) Patent Application Publication
(10) Pub. No.: US 2022/0245986 A1
(43) Pub. Date: Aug. 4, 2022

(54) FOOD AND BEVERAGE SUPPLY DEVICE

(71) Applicant: Konica Minolta, Inc., Tokyo (JP)

(72) Inventors: SABUROU HIRAOKA, Kodaira-shi, Tokyo (JP); TAKESHI HAKII, Midori-ku, Sagamihara-shi, Kanagawa (JP); TOMOHIRO UCHIDA, Ebina-shi, Kanagawa (JP)

(21) Appl. No.: 17/623,823

(22) PCT Filed: Jul. 10, 2020
(86) PCT No.: PCT/JP2020/027099

§ 371 Date: Dec. 29, 2021

(30) Foreign Application Priority Data
Jul. 23, 2019 (JP) 2019-135384

(51) Int. Cl. G07F 13/10; G06K 7/10; B67D 1/08; A47J 31/52

(52) U.S. Cl. CPC G07F 13/10; A47J 31/521; B67D 1/0888; G06K 7/10366

(57) ABSTRACT

A food and beverage supply device provided with a main body (10) including a container placing table (10a), a reader (15) that includes an antenna (15a) arranged adjacent to the container placing table (10a), transmits an electromagnetic wave from the antenna (15a) to a container (100) placed on the container placing table (10a), and reads identification information of an identifier (100a) attached to the container (100), and a controller (13) that controls the main body (10) so as to specify a type of food and beverage to be supplied to the container (100) on the basis of the identification information of the identifier (100a), and supply a specified type of food and beverage to the container (100).

### TECHNICAL FIELD

The present disclosure relates to a food and beverage supply device.

### BACKGROUND ART

A food and beverage supply device including a plurality of types of raw material supply sources, the food and beverage supply device that supplies a desired beverage selected by a user to a container is conventionally known (refer to, for example, Patent Literatures 1 and 2). This type of food and beverage supply device is installed in a store, for example, and serves as a self-service server so that a customer may receive a beverage matching his/her taste.

### CITATION LIST

### Patent Literature

Patent Literature 1: WO 2016/069992

Patent Literature 2: JP 2013-094270 A

### SUMMARY OF INVENTION

### Technical Problem

By the way, in this type of food and beverage supply device, due to an erroneous operation of a user, there is a possibility that a beverage of a type not desired by the user is supplied, or a beverage of an amount different from the amount desired by the user is supplied.

On the other hand, in a case where this type of food and beverage supply device is used as a self-service server installed in a store, there also is a problem that it is not possible to avoid a risk that the user acts fraudulently and receives a different type or amount of beverage from a purchased product.

The present disclosure is achieved in view of the above-described problem, and an object thereof is to provide a food and beverage supply device capable of suppressing an erroneous operation and a fraud by a user.

### Solution to Problem

The present disclosure for solving the above-described problem principally is

a food and beverage supply device provided with:

a main body including a container placing table;

a reader that includes an antenna arranged adjacent to the container placing table, transmits an electromagnetic wave from the antenna to a container placed on the container placing table, and reads identification information of an identifier attached to the container; and

a controller that controls the main body so as to specify a type of food and beverage to be supplied to the container on the basis of the identification information of the identifier, and supply a specified type of food and beverage to the container.

### Advantageous Effects of Invention

According to the food and beverage supply device according to the present disclosure, it is possible to suppress an erroneous operation and a fraud of a user.

### BRIEF DESCRIPTION OF DRAWINGS

FIG. 1 is a view illustrating an overall configuration of a food and beverage supply device according to a first embodiment.

FIG. 2 is a view for explaining an RFID system of the food and beverage supply device according to the first embodiment.

FIG. 3 is a view illustrating an example of a data configuration of a food and beverage type data table referred to by a controller of the food and beverage supply device according to the first embodiment.

FIG. 4 is a perspective view illustrating a peripheral portion of a container placing table of the food and beverage supply device according to the first embodiment.

FIG. 5 is a view illustrating a sequential flow when the food and beverage is supplied to the container by the food and beverage supply device according to the first embodiment.

FIG. 6 is a view illustrating an example of a configuration of a food and beverage supply device according to a second embodiment.

FIG. 7 is a view illustrating an example of a configuration of a food and beverage supply device according to a third embodiment.

FIG. 8 is a view illustrating an example of a configuration of an RFID system of a food and beverage supply device according to a fourth embodiment.

### DESCRIPTION OF EMBODIMENTS

Hereinafter, preferred embodiments of the present disclosure are described in detail with reference to the accompanying drawings. Note that, in this specification and the drawings, components having substantially the same function are assigned with the same reference sign, and the description thereof is not repeated.

### First Embodiment

<Overall Configuration of Food and Beverage Supply Device>

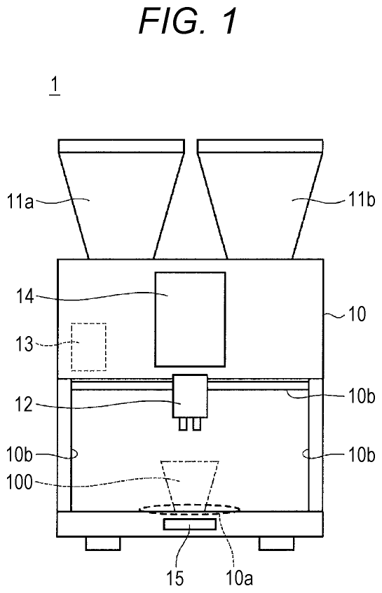

Hereinafter, an example of a configuration of a food and beverage supply device according to a first embodiment is described with reference to FIG. 1. In this embodiment, an example in which a food and beverage supply device 1 is applied to a self-service coffee server device arranged in a store is described.

FIG. 1 is a view illustrating an overall configuration of the food and beverage supply device 1 according to this embodiment.

The food and beverage supply device 1 is provided with a main body 10, raw material supply sources 11a and 11b, a nozzle 12, a controller 13, an HMI 14, and a reader 15.

The main body 10 produces a food and beverage (herein, coffee) to be supplied from a raw material (herein, powdery coffee beans) supplied from the raw material supply sources 11a and 11b.

The main body 10 includes, for example, a control valve (not illustrated) between the raw material supply sources 11a and 11b, and selectively acquires a desired type of raw material from the raw material supply sources 11a and 11b by opening and closing the control valve corresponding to a command from the controller 13.

In the main body 10, for example, a dripper, a boiler, a water supply unit, a steam generation unit, a stirring unit and the like (not illustrated) are accommodated. Each unit of the main body 10 operates to produce a designated amount of food and beverage of a type designated by the controller 13 on the basis of the command from the controller 13. Since a configuration for producing the food and beverage in the main body 10 is similar to a configuration of a conventionally known food and beverage supply device, the description thereof is herein omitted (refer to, for example, Patent Literatures 1 and 2).

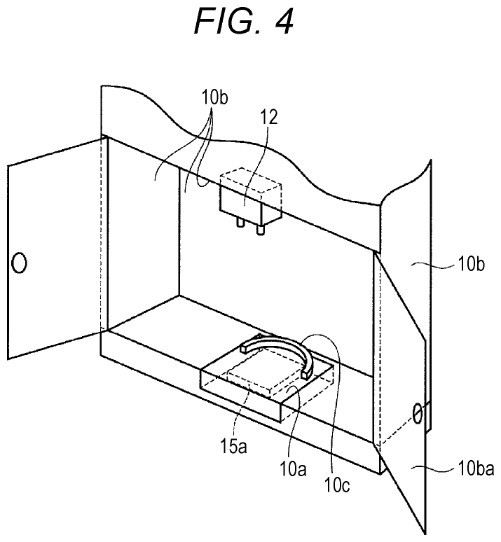

Note that the main body 10 includes a container placing table 10a (that is, a container placing space) at the front for placing a container 100 to which the food and beverage is to be supplied. The main body 10 includes an electromagnetic wave absorbing material 10b so as to surround the periphery of the container placing table 10a (to be described later with reference to FIG. 4).

The raw material supply sources 11a and 11b are arranged above the main body 10 and hold raw materials for producing the food and beverage to be supplied. The food and beverage supply device 1 is provided with a plurality of raw material supply sources 11a and 11b (only two of them are illustrated in FIG. 1) that holds a plurality of types of raw materials different from each other so that a plurality of types of food and beverage may be supplied.

Examples of the plurality of types of raw materials held by the raw material supply sources 11a and 11b include a plurality of types of coffee beans of different brands, milk to be blended with coffee, other flavors and the like, for example. Note that the raw materials held by the raw material supply sources 11a and 11b are not limited to the raw material that requires a food and beverage production process in the main body 10 like coffee beans, and may be a food and beverage itself that may be supplied as is from the main body 10.

The nozzle 12 is attached to the front of the main body 10 and discharges the food and beverage produced by the main body 10. The nozzle 12 is arranged above the container placing table 10a of the main body 10.

The controller 13 integrally controls an operation of the food and beverage supply device 1. The controller 13 is communicably connected to the main body 10, the HMI 14, and the reader 15, for example, and exchanges necessary data and control signals with these components. The controller 13 is a microcomputer including a central processing unit (CPU), a read only memory (ROM), a random access memory (RAM), an input port, an output port and the like, for example.

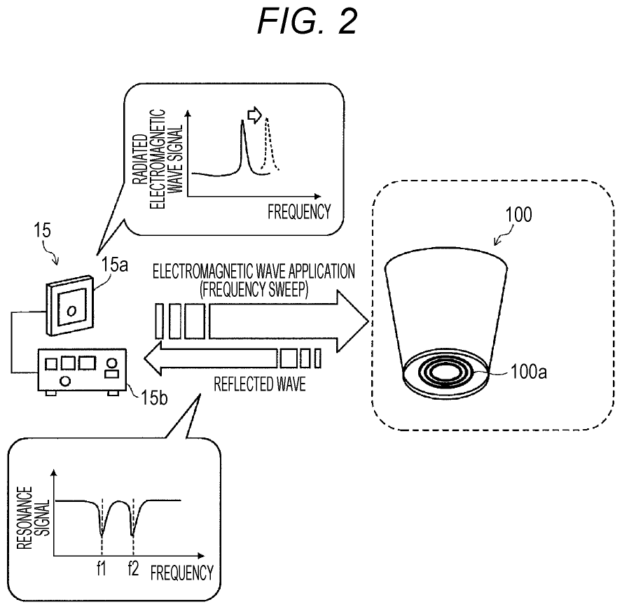

The controller 13 controls the main body 10 so that the food and beverage of a type corresponding to identification information of an identifier 1 acquired from the reader 15 is supplied from the nozzle 12 (to be described later with reference to FIG. 2). Note that the controller 13 may be configured to control the main body 10 so as to select one type of raw material from a plurality of types of raw material supply sources (herein, 11a and 11b) and produce the food and beverage of the selected raw material, or may be configured to control the main body 10 so as to select two or more types of raw materials out of the plurality of types of raw material supply sources and produce the food and beverage in which selected two or more types of raw materials are blended at a predetermined ratio.

The human machine interface (HMI) 14 (corresponding to a “display unit” of the present invention) is formed of, for example, a touch panel type liquid crystal display, and displays contents instructed by the controller 13. The HMI 14 displays, for example, information regarding a type and an amount of food and beverage (that is, identification information of an identifier 100a illustrated in FIG. 2) to be supplied to the container 100 read by the reader 15. The HMI 14 is configured to be able to receive a food and beverage supply execution command from a user.

The reader 15 transmits an electromagnetic wave to the container 100 placed on the container placing table 10a of the main body 10, and reads the identification information of the identifier 100a (refer to FIG. 2) attached to the container 100.

<RFID System of Food and Beverage Supply Device>

Next, an RFID system of the food and beverage supply device 1 according to this embodiment is described.

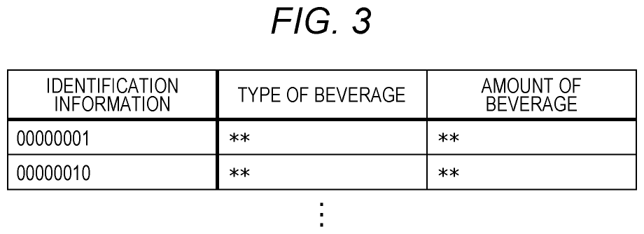

FIG. 2 is a view for explaining the RFID system of the food and beverage supply device 1 according to this embodiment. FIG. 3 is a view illustrating an example of a data configuration of a food and beverage type data table referred to by the controller 13 of the food and beverage supply device 1 according to this embodiment.

The container 100 received by the user at a checkout counter of the store is placed on the container placing table 10a of the food and beverage supply device 1 (refer to FIG. 1), for example. To the container 100, for example, the identifier 100a (an identifier including an RFID, an IC tag, and a resonator and the like; hereinafter, described as the identifier including the resonator) that defines the identification information regarding the type and amount of food and beverage to be supplied to the container 100 is attached. Note that, as the container 100 herein used, for example, a disposable paper cup and the like is used.

Specifically, the identifier 100a is formed of the resonator that resonates with the electromagnetic wave at a specific frequency. That is, the identifier 100a forms the identification information by a resonance frequency of such resonator.

FIG. 2 illustrates a ring slot resonator as an example of the resonator of the identifier 100a. The ring slot resonator is formed of a ring-shaped slot pattern provided so as to hollow out a conductor layer formed on a base material (herein, the container 100). The ring slot resonator resonates with, when a wavelength of an applied electromagnetic wave corresponds to a length of its own ring-shaped slot pattern, the electromagnetic wave. Note that, since the ring slot resonator does not have directivity regarding a polarization direction of the electromagnetic wave, this is useful in that the user may place the container 100 on the container placing table 10a without minding the direction of the container 100.

The identifier 100a illustrated in FIG. 2 includes, for example, a first ring slot resonator having the resonance frequency at a first frequency f1 and a second ring slot resonator having the resonance frequency at a second frequency f2, and the first frequency f1 and the second frequency f2 form the identification information. Such identification information is represented as, for example, “0010100” (a right side represents a first digit) and the like in which an identification code of a digit corresponding to the first frequency f1 (for example, a third digit) is “1”, and an identification code of a digit corresponding to the second frequency f2 (for example, a fifth digit) is “1”. Note that the resonator of the identifier 100a is typically formed to have the resonance frequency of 1 GHz to 90 GHz from the viewpoint of miniaturization.

The identifier 100a desirably has, for example, a reflection characteristic of absorbing the electromagnetic wave at a frequency matching the resonance frequency of the resonator and reflecting the electromagnetic waves at other frequencies. The identifier 100a desirably forms the identification information by using a power loss (absorption) due to resonance as a signal.

Note that the identifier 100a may be directly printed on the container 100, or that printed on a sealing base material and the like may be adhered to the container 100.

The reader 15 reads the identification information defined by the identifier 100a by detecting the resonance frequency (in FIG. 2, the first frequency f1 and the second frequency f2) of the identifier 100a (representing the resonance frequency of the resonator included in the identifier 100a; the same applies to the following). Then, the reader 15 specifies the type and amount of food and beverage to be supplied to the container 100, and executes the food and beverage supply device so as to reflect the specified type and amount of food and beverage.

Specifically, the reader 15 includes an antenna 15a and a control unit 15b.

The antenna 15a transmits the electromagnetic wave at a predetermined frequency on the basis of a drive signal from the control unit 15b. The antenna 15a receives a reflected wave from the identifier 100a when the electromagnetic wave is transmitted, and outputs the same to the control unit 15b.

A transmission frequency of the electromagnetic wave transmitted by the antenna 15a is, for example, a sine wave having peak intensity at a single frequency. Then, the transmission frequency of the electromagnetic wave is subjected to a frequency sweep in an entire region or a partial region of the above-described frequency band {for example, a UWB band (7.25 GHz to 10.25 GHz)} on the basis of the drive signal from the control unit 15b.

As the antenna 15a, for example, a plate-shaped antenna (for example, a linearly polarized patch antenna) is desirably used from the viewpoint of miniaturization. However, as the antenna 15a, a linear antenna such as a dipole antenna, a loop antenna, and a helical antenna, an aperture antenna such as a parabola antenna, a cassegrain antenna, a dielectric antenna, and a horn antenna, a phased array antenna that is an aggregate of these antennas and the like may be used.

The antenna 15a is arranged below the container placing table 10a or arranged so as to be incorporated in the container placing table 10a, for example, and transmits the electromagnetic wave upward (to be described later with reference to FIG. 4). Note that the antenna 15a (linearly polarized patch antenna) according to this embodiment transmits, for example, the electromagnetic wave having polarization in a uniaxial direction.

The control unit 15b is mainly formed of a known microcomputer including, for example, a CPU, a ROM, a RAM and the like, and is provided with a drive circuit that generates a high-frequency drive signal to be transmitted to the antenna 15a, a detection circuit that performs reception processing of a reflected wave signal from the antenna 15a and the like in addition to this. However, it goes without saying that a part of the control unit 15b may be implemented only by a dedicated hardware circuit without including the CPU and the like. Note that the processing performed by the control unit 15b is similar to that in the known configuration, so that detailed description thereof is herein omitted.

When collating the identification information of the identifier 100a, the control unit 15b generates the drive signal (for example, a sine-wave signal) according to the electromagnetic wave transmitted from the antenna 15a, and supplies the same to the antenna 15a. Then, the control unit 15b temporally changes the transmission frequency of the electromagnetic wave transmitted from the antenna 15a, and performs the frequency sweep in a predetermined frequency band set in advance (for example, continuous change from 7.25 GHz to 10.25 GHz).

The control unit 15b acquires the reflected wave from the identifier 100a when the electromagnetic wave at each frequency is transmitted from the antenna 15a, and detects the resonance frequency of the identifier 100a on the basis of the reflection characteristic thereof. Note that, the resonance frequency of the identifier 100a is herein detected as a change in intensity of the reflected wave from the identifier 100a (resonance peak) when this matches the transmission frequency of the electromagnetic wave transmitted by the antenna 15a.

In this manner, the control unit 15b detects the resonance frequency of the identifier 100a, recognizes the resonance frequency as the identification information of the identifier 100a, and transmits the same to the controller 13 of the food and beverage supply device 1. Note that, at that time, the control unit 15b may convert the resonance frequency of the identifier 100a into a bit signal on the basis of a data conversion algorithm determined in advance and transmit the same to the controller 13.

The controller 13 of the food and beverage supply device 1 specifies the type and amount of food and beverage to be supplied to the container 100 on the basis of the food and beverage data table (refer to FIG. 3) stored in advance in the ROM and the like (not illustrated) and the identification information of the identifier 100a.

Note that FIG. 3 illustrates, as an example of the food and beverage type data table, data in which the type and amount of food and beverage are defined in association with the identification information (herein, the resonance frequency is converted into the bit signal) of the identifier 100a. However, such data may further include information regarding a blend ratio of a plurality of types of food and beverage, a concentration of the food and beverage, a type of additive, temperature of the food and beverage and the like.

An identifier readable distance by the reader 15 is preferably 15 cm or shorter. The identifier readable distance is a threshold of a distance at which the reader 15 may identify the identification information of the identifier, and the identifier cannot be read at a distance exceeding the threshold. This distance of 15 cm is a distance that minimally exceeds a size of a container 200 placed on the food and beverage supply device 1, and is a sufficient distance to read only the identifier attached to the container 200. Examples of means for setting the identifier readable distance to 15 cm or shorter include adjustment of an applied radio wave output from the antenna 15a.

<Detailed Configuration of Main Body>

Next, a detailed configuration of a peripheral portion of the container placing table 10a of the main body 10 is described.

FIG. 4 is a perspective view illustrating the peripheral portion of the container placing table 10a of the food and beverage supply device 1 according to this embodiment.

The main body 10 includes the electromagnetic wave absorbing material 10b arranged so as to surround the periphery of the container placing table 10a, and a positioning unit 10c that positions the container 100 placed on the container placing table 10a.

The antenna 15a is arranged below the container placing table 10a of the main body 10 so that the electromagnetic wave may be transmitted upward. As a result, the antenna 15a may transmit the electromagnetic wave to a bottom surface (that is, the surface to which the identifier 100a is attached) of the container 100 placed on the container placing table 10a and receive the reflected wave from the container 100.

The container placing table 10a is formed as an attachable/detachable pedestal in which the antenna 15a is incorporated. As a result, dirt adhering to the container placing table 10a may be easily removed. As a result, the antenna 15a may be easily replaced. Note that the container placing table 10a according to this embodiment incorporates both the antenna 15a and the control unit 15b.

The electromagnetic wave absorbing material 10b absorbs the electromagnetic wave that misses the container 100 out of the electromagnetic waves transmitted from the antenna 15a. That is, the electromagnetic wave absorbing material 10b suppresses the electromagnetic wave that misses the container 100 out of the electromagnetic waves transmitted from the antenna 15a from being reflected outside the food and beverage supply device 1 to return to the antenna 15a again. As a result, a situation is suppressed in which an SN ratio when detecting the reflection characteristic of the identifier 100a is deteriorated due to the electromagnetic wave reflected outside the food and beverage supply device 1 and the reader 15 erroneously recognizes the identification information of the identifier 100a.

The electromagnetic wave absorbing material 10b is arranged, for example, at the front, back, right, and left of the container placing table 10a and above the container placing table 10a, and forms a wall such that an accommodating space for accommodating the container 100 placed on the container placing table 10a is substantially sealed.

The electromagnetic wave absorbing material 10b on a front side of the main body 10 (that is, a front surface side of the container placing table 10a) forms an opening/closing door 10ba enabling carrying-in from an external space to the container placing table 10a and carrying-out. For example, the opening/closing door 10ba is formed of a transparent member to make the inside visible.

The electromagnetic wave absorbing material 10b may have any known configuration as long as this may absorb the electromagnetic wave at a frequency utilized for reading the identifier. The electromagnetic wave absorbing material 10b is formed of, for example, a material such as a conductive absorbing material that absorbs a current generated by the electromagnetic wave due to a resistance loss inside a material, a dielectric radio wave absorbing material (for example, carbon) that utilizes a dielectric loss caused by a polarization reaction of molecules, or a magnetic radio wave absorbing material (for example, iron, nickel, and ferrite) that absorbs the radio wave due to a magnetic loss, and thus has a characteristic of absorbing the electromagnetic wave. In addition to this, a λ/4 electromagnetic wave absorber may be used as the electromagnetic wave absorbing material 10b.

The positioning unit 10c positions a placement position of the container 100 so that the container 100 is placed in a position facing the antenna 15a when the user places the container 100 on the container placing table 10a. In this embodiment, the positioning unit 10c is formed on an upper surface of the container placing table 10a as a protrusion having a shape (for example, an arc shape) along an outer shape of the bottom portion of the container 100.

As a result, a large part of the electromagnetic waves transmitted from the antenna 15a may be applied to the identifier 100a attached to the container 100. That is, the SN ratio when detecting the reflection characteristic of the identifier 100a may be improved by this.

Note that any configuration of the positioning unit 10c is applicable, and for example, this may be formed of a container gripping mechanism that grips the container 100 so that the container 100 is placed in a desired position.

<Operation Flow of Food and Beverage Supply Device>

Next, an operation flow when the food and beverage is supplied to the container 100 by the food and beverage supply device 1 is described.

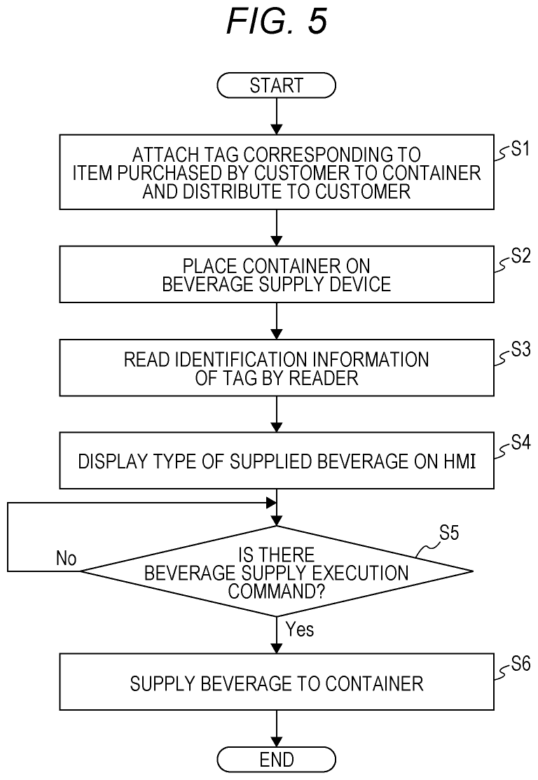

FIG. 5 is a view illustrating a sequential flow when the food and beverage is supplied to the container 100 by the food and beverage supply device 1 according to this embodiment. Note that, in the operation flow in FIG. 5, steps S3 to S6 indicate processing executed by the controller 13 according to a computer program.

First, when a customer (corresponding to the user) purchases a food and beverage, a store clerk attaches the identifier 100a (for example, a seal-type identifier 100a) corresponding to the food and beverage purchased by the customer (the type and amount of food and beverage) to the container 100 and distributes the same to the customer (step S1).

Next, the customer carries the received container 100 to a place where the food and beverage supply device 1 is located, and places the container 100 on the container placing table 10a of the food and beverage supply device 1 (step S2).

Next, the food and beverage supply device 1 reads the identification information of the identifier 100a by the reader 15 (step S3). Note that the reader 15 typically constantly monitors presence of the container 100 (identifier 100a) placed on the container placing table 10a, and reads the identification information of the identifier 100a as the container 100 is placed on the container placing table 10a.

Next, the food and beverage supply device 1 specifies the type of food and beverage to be supplied to the container 100 on the basis of the identification information of the identifier 100a, and displays information regarding the specified type of food and beverage on the HMI 14 (step S4).

Next, the food and beverage supply device 1 stands by for the food and beverage supply execution command from the user to be input to the HMI 14 (S5: No). Then, in a case where the food and beverage supply execution command from the user is input to the HMI 14 (S5: Yes), the food and beverage supply device 1 supplies the food and beverage regarding the type of food and beverage indicated by the identification information of the identifier 100a to the container 100 (step S6).

In this manner, it is possible to execute food and beverage supply by the food and beverage supply device 1 without causing the user to perform an operation regarding the type of food and beverage and the like.

### Effect

As described above, according to the food and beverage supply device 1 of this embodiment, it is possible to supply a desired food and beverage to the container 100 without causing the user to perform a complicated operation. As a result, it is possible to suppress supply of the food and beverage of a type different from the desired food and beverage or supply of the food and beverage of an amount different from a desired amount to the container 100 due to the erroneous operation of the user. Since the type and amount of food and beverage may be regulated by the identifier 100a attached to the container 100 by this, the food and beverage supply device 1 may be used as a self-service server with a fraudulent act prevention function.

Especially, the food and beverage supply device 1 according to this embodiment has a configuration of reading the identification information of the identifier 100a attached to the container 100 using the electromagnetic wave. Therefore, unlike a case of using an optical identifier (for example, a QR code (registered trademark)), the food and beverage supply device 1 according to this embodiment may read the identification information of the identifier 100a attached to the container 100 even in a state in which dirt adheres to the container 100 or the container placing table 10a.

The food and beverage supply device 1 according to this embodiment uses the resonator that resonates with the electromagnetic wave at a specific frequency as the identifier 100a attached to the container 100. As a result, it is possible to easily attach various pieces of identification information to the container at a low cost.

### Second Embodiment

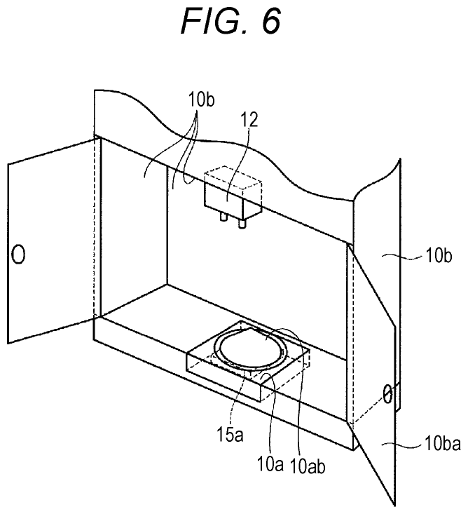

FIG. 6 is a view illustrating an example of a configuration of a food and beverage supply device 1 according to a second embodiment.

The food and beverage supply device 1 according to this embodiment is different from that of the first embodiment in that a container placing table 10a includes a moisture avoiding structure 10ab. Note that description of the configuration common to that of the first embodiment is omitted (the same applies to other embodiments).

The moisture avoiding structure 10ab is a structure for suppressing moisture from remaining in a region facing an antenna 15a of the container placing table 10a. The moisture avoiding structure 10ab is, for example, a conical protrusion formed on the container placing table 10a. As a result, in a case where moisture spills from the nozzle 12 on the container placing table 10a, the moisture flows out of the container placing table 10a. As a result, intensity of an electromagnetic wave transmitted by the antenna 15a is suppressed from being weakened by the moisture remaining on the container placing table 10a.

Note that any configuration of the moisture avoiding structure 10ab is applicable, and for example, the moisture avoiding structure 10ab may be formed by the container placing table 10a formed of a water-repellent member.

As described above, according to the food and beverage supply device 1 according to this embodiment, an SN ratio when detecting a reflection characteristic of an identifier 100a may be further improved, and reading sensitivity of the identification information of the identifier 100a may be improved.

### Third Embodiment

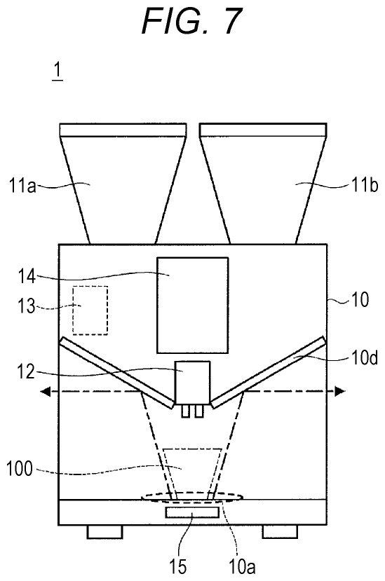

FIG. 7 is a view illustrating an example of a configuration of a food and beverage supply device 1 according to a third embodiment.

The food and beverage supply device 1 according to this embodiment is different from the food and beverage supply device 1 according to the first embodiment in that a main body 10 is provided with, in place of the electromagnetic wave absorbing material 10b, an electromagnetic wave reflecting material 10d that externally dissipates an electromagnetic wave that misses a container 100 out of the electromagnetic waves transmitted from an antenna 15a to outside.

The electromagnetic wave reflecting material 10d is arranged, for example, above a container placing table 10a. The electromagnetic wave reflecting material 10d has, for example, a plate shape, and is arranged so as to be inclined so that its own reflection surface (that is, a lower surface) faces an outer side of the food and beverage supply device 1 in a lateral direction.

With such a configuration, the electromagnetic wave reflecting material 10d reflects the electromagnetic wave that misses the container 100 coming from below on the outer side of the food and beverage supply device 1 in the lateral direction.

As described above, according to the food and beverage supply device 1 of this embodiment, it is possible to suppress the electromagnetic wave that misses the container 100 from being reflected outside to return to the antenna 15a. As a result, an SN ratio when detecting a reflection characteristic of the identifier 100a may be further improved, and reading sensitivity of the identification information of the identifier 100a may be improved.

### Fourth Embodiment

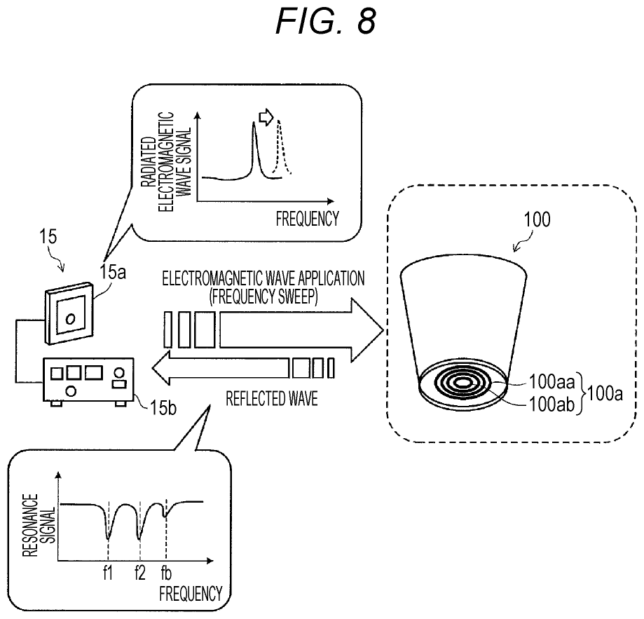

FIG. 8 is a view illustrating an example of a configuration of an RFID system of a food and beverage supply device 1 according to a fourth embodiment.

In the food and beverage supply device 1 according to this embodiment, the RFID system different from the RFID system according to the first embodiment is applied.

An identifier 100a attached to a container 100 according to this embodiment is different from the identifier 100a according to the first embodiment in including an information forming resonator 100aa and a calibration resonator 100ab. Herein, as described in the above-described embodiment, the information forming resonator 100aa is the resonator forming identification information of the identifier 100a, and the calibration resonator 100ab is the resonator not forming the identification information.

In general, a resonance frequency of the resonator might be shifted due to a change in dielectric constant of a base material (herein, the container 100) caused by a change in temperature or humidity (also referred to as a wavelength shortening effect). In such a case, if no correction is made, when reading the identification information of the identifier 100a, a reader 15 might read identification information different from the identification information originally assigned to the identifier 100a.

From such a viewpoint, the identifier 100a according to this embodiment includes the calibration resonator 100ab for detecting a frequency shift from a reference frequency determined in advance. The calibration resonator 100ab is arranged, for example, in proximity to the information forming resonator 100aa, and is configured so that its own resonance frequency is detected together with the resonance frequency of the information forming resonator 100aa when the reader 15 reads the identification information.

The calibration resonator 100ab is configured to indicate a resonance peak at a reference frequency determined in advance (represented by a frequency fb in FIG. 8). Note that the reference frequency is typically set to a frequency separated from a frequency band in which the resonance frequency of the information forming resonator 100aa is set (for example, separated by about 1 GHz) so as to be clearly distinguished from the resonance frequency of the information forming resonator 100aa.

Specifically, a control unit 15b of the reader 15 according to this embodiment reads the identification information of the identifier 100a by the following processing.

First, the control unit 15b temporally changes a transmission frequency of an electromagnetic wave to be transmitted from an antenna 15a, performs a frequency sweep within a predetermined frequency band set in advance, and acquires a reflection characteristic (that is, frequency characteristic) of the identifier 100a.

Next, the control unit 15b specifies the resonance frequency of the calibration resonator 100ab from the reflection characteristic of the identifier 100a, and detects a shift amount from the reference frequency determined in advance. Thereafter, the control unit 15b performs correction to increase or decrease the frequency by the shift amount with respect to the resonance frequency of the information forming resonator 100aa specified from the reflection characteristic of the identifier 100a. In this manner, the control unit 15b specifies the resonance frequency of the information forming resonator 100aa after the correction as the identification information of the identifier 100a.

As described above, according to the food and beverage supply device 1 according to this embodiment, it is possible to accurately read the identification information of the identifier 100a even in a case where the frequency shift of the resonance frequency of the resonator forming the identifier 100a occurs due to the change in temperature or humidity.

### Other Embodiments

The present invention is not limited to the above-described embodiments, and various modified aspects are conceivable.

In the above-described embodiments, an example of the configuration of the food and beverage supply device 1 is variously described. However, it goes without saying that various combinations of the aspects described in the respective embodiments may be used.

In the above-described embodiments, a coffee server device is described as an example of an applied aspect of the food and beverage supply device 1. However, the food and beverage supply device 1 of the present invention is also applicable when supplying various foods and beverages other than coffee. Examples thereof include beverages such as tea, juice, soft beverage, and beer, soups, and food products prepared by pouring an appropriate amount of hot water or soup stock in a cup in which freeze-dried solid food is put, for example.

In the above-described embodiments, the identifier including the resonator is described as an example of the identifier 100a attached to the container 100. However, even when an RFID tag or an IC tag including a chip is used as the identifier 100a of the present invention in place of the identifier including the resonator, a similar effect may be obtained.

In the above-described embodiments, the configuration in which the antenna 15a is incorporated in the container placing table 10a is described as an example of an arrangement position of the antenna 15a. However, the antenna 15a of the present invention may also be provided on a side wall of the food and beverage supply device 1. In this case, the identifier 100a is provided on a side surface of the container 100.

A function of detecting dirt on the container placing table 10a may be further added to the food and beverage supply device 1 described in the above-described embodiment. Such function may be implemented, for example, by designating in advance a reference value of intensity at which the container 100 reflects the electromagnetic wave when the reader 15 transmits the electromagnetic wave to the container 100. In this case, for example, in a case where the intensity of the reflected wave from the container 100 is equal to or smaller than the reference value, the reader 15 may determine that the container placing table 10a is dirty and cause the HMI 14 to display the same.

Although specific examples of the present invention are described above in detail, they are merely examples, and do not limit the scope of claims. The technology recited in claims includes various modifications and changes of the specific examples exemplified above.

The entire disclosure of the specification, drawings, and abstract included in Japanese Patent Application No. 2019-135384 filed on Jul. 23, 2019 is incorporated herein by reference.

### INDUSTRIAL APPLICABILITY

According to the food and beverage supply device according to the present disclosure, it is possible to suppress an erroneous operation and a fraud of a user.

### REFERENCE SIGNS LIST

1 Food and beverage supply device
10 Main body
10a Container placing table
10ab Moisture Avoiding Structure
10b Electromagnetic wave absorbing material
10ba Opening/closing door
10c Positioning unit
10d Electromagnetic wave reflecting material
11a, 11b Raw material supply source
12 Nozzle
13 Controller
14 HMI
15 Reader
15a Antenna
15b Control unit
100 Container
100a Identifier
100aa Information forming resonator
100ab Calibration resonator

1. A food and beverage supply device comprising:
a main body including a container placing table;
a reader that includes an antenna arranged adjacent to the container placing table, transmits an electromagnetic wave from the antenna to a container placed on the container placing table, and reads identification information of an identifier attached to the container; and
a hardware processor that controls the main body so as to specify a type of food and beverage to be supplied to the container on the basis of the identification information of the identifier, and supply a specified type of food and beverage to the container.

2. The food and beverage supply device according to claim 1, wherein
a readable distance of the identifier by the reader is 15 cm or shorter.

3. The food and beverage supply device according to claim 1, wherein
the identifier includes a resonator that resonates with an electromagnetic wave at a specific frequency, and forms the identification information by a reflection characteristic when the electromagnetic wave is applied from the antenna.

4. The food and beverage supply device according to claim 3, wherein
the reader sweeps a transmission frequency of the electromagnetic wave transmitted from the antenna and detects the reflection characteristic of the identifier.

5. The food and beverage supply device according to claim 4, wherein
the resonator includes an information forming resonator and a calibration resonator, and
the reader reads the identification information formed of a resonance frequency of the information forming resonator on the basis of a resonance frequency of the calibration resonator detected when the electromagnetic wave is applied to the identifier.

6. The food and beverage supply device according to claim 3, wherein
the resonator is a ring slot resonator.

7. The food and beverage supply device according to claim 1, wherein
the main body is provided with an electromagnetic wave absorbing material arranged so as to surround a periphery of the container placing table.

8. The food and beverage supply device according to claim 7, wherein
the electromagnetic wave absorbing material includes an opening/closing door for carrying the container from an external space into the container placing table or carrying the container from the container placing table to the external space.

9. The food and beverage supply device according to claim 1, wherein
the main body is provided with an electromagnetic wave reflecting material that is arranged around the container placing table and externally dissipates an electromagnetic wave that misses the container out of electromagnetic waves transmitted from the antenna.

10. The food and beverage supply device according to claim 1, wherein
the antenna is arranged below the container placing table or so as to be incorporated in the container placing table, and transmits the electromagnetic wave to the identifier attached to a bottom surface of the container.

11. The food and beverage supply device according to claim 10, wherein
the container placing table includes a moisture avoiding structure, in a region facing the antenna, for suppressing moisture from remaining in the region.

12. The food and beverage supply device according to claim 10, wherein
the container placing table is formed as a pedestal that incorporates the antenna and is attachable to and detachable from the main body.

13. The food and beverage supply device according to claim 1, wherein
the main body includes a positioning unit positioner that positions the container placed on the container placing table.

14. The food and beverage supply device according to claim 1, further comprising:
a display that displays information regarding the type of food and beverage specified on the basis of the identification information.

15. The food and beverage supply device according to claim 1, wherein
the identification information of the identifier further includes information regarding an amount of food and beverage to be supplied to the container.

16. The food and beverage supply device according to claim 1, wherein
the identifier is attached by being printed directly on the container.

17. The food and beverage supply device according to claim 1, wherein
the container is a disposable container.

18. The food and beverage supply device according to claim 2, wherein
the identifier includes a resonator that resonates with an electromagnetic wave at a specific frequency, and forms the identification information by a reflection characteristic when the electromagnetic wave is applied from the antenna.

19. The food and beverage supply device according to claim 2, wherein
the main body is provided with an electromagnetic wave absorbing material arranged so as to surround a periphery of the container placing table.

20. The food and beverage supply device according to claim 2, wherein
the main body is provided with an electromagnetic wave reflecting material that is arranged around the container placing table and externally dissipates an electromagnetic wave that misses the container out of electromagnetic waves transmitted from the antenna.
